(19) United States
(12) Patent Application Publication
(10) Pub. No.: US 2004/0199418 A1
(43) Pub. Date: Oct. 7, 2004

(54) Method and system for character portrait identification through an interactive terminal for entertainment, revenue generation and marketing application

(76) Inventors: Paul T. Hertz, Miami Beach, FL (US); Debra Levine Hertz, Miami Beach, FL (US)

Correspondence Address: LOTT & FRIEDLAND, P.A., P.O. BOX 141098, CORAL GABLES, FL, 33114-1098, US

(21) Appl. No.: 10/678,681

(22) Filed: Oct. 3, 2003

Related U.S. Application Data
(63) Continuation-in-part of application No. 09/871,437, filed on May 31, 2001, now abandoned.

(51) Int. Cl. G06F 17/60

(52) U.S. Cl. 705/10

(57) ABSTRACT

A method and system of identifying Character Portraits using a Character Portrait Dynamic Identification Processing System with Character Portrait Identification Codes as a form of entertainment through an interactive terminal. In addition to being entertaining, the Character Portrait System can be useful for providing revenue and information on the people using the System for making targeted marketing decisions regarding those people. Specific applications include the cruise, hotel and airline industries.

### CLAIM OF PRIORITY

This is a continuation-in-part of U.S. patent application Ser. No. 09/871,437, currently pending.

### FIELD OF INVENTION

The present invention relates generally to a system for identifying individual Character Portraits, and more particularly, to a method and system of identifying individual Character Portraits as a form of entertainment and revenue generation. In addition to being entertaining and generating revenue, the Character Portrait System can be useful for providing information about users of the Character Portrait System and for making targeted decisions regarding those people.

### BACKGROUND OF THE INVENTION

Every year millions of people choose to spend their vacations away from home. Many of these vacationers travel on airplanes, stay in hotels, or take cruises where they are room- or cabin-bound for at least part of their vacation. Typically, not many forms of recreation are available while in the ship/aircraft cabin or room, perhaps television, a movie, or reading a book. Naturally, it would be preferable to the vacationer if there were more entertainment options in the room and unless the vacationer orders a pay-per-view type of movie to watch on television, the current forms of indoor recreation do not typically provide the airline, hotel or cruise ship line with any discernible benefit.

Not only is there a dearth of entertainment options for the vacationer, but the sheer numbers of annual vacation travelers present a tremendous source of potential revenue and information for cruise lines, airlines or hotel operators which is currently being lost. More than 60 million people have vacationed on cruise ships alone over the past two decades. A recent study sponsored by Cruise Lines International Association found that more than almost 69 million Americans would like to take a cruise in the next five years, and more than 43 million say they definitely or probably will cruise in that period. Those prospects represent a potential cruise vacation market of at least $57 billion and as much as $85 billion. Nearly 7.5 million North Americans vacationed on cruise ships in 2001, and over 10 million in 2002. Any opportunity to generate additional revenue while at the same time entertaining passengers and guests is welcomed by the travel and leisure industry.

In addition to a lack of entertainment options for the typical vacationer and lost revenue for the vacation providers, the airlines, cruise ship lines and hotel operators fail to take advantage of an opportunity to collect information on their customers. Character Portrait information can be used to help segment the vacationer market and provide useful information for targeted marketing programs.

Market segmentation is a broad term used in market research that covers a host of different possible approaches to analyzing customers. Broadly speaking, it focuses on dividing customers into groups that can be further analyzed for a number of different issues. In other words, to maximize the wealth of information in the acquired data, one has to dig deeper than the surface. A company needs to understand the characteristics of its target customer, not just the industry they are in. A market analysis, such as a Character Portrait System for vacationers, would assist a company in providing information about users of the Character Portrait System and for making targeted decisions regarding those people.

This being said, there are a number of methodologies for conducting such a market analysis and segmentation.

Previous attempts have been made to provide personality typing mechanisms or characteristic matching methods as described in U.S. Pat. No. 6,334,110 to Walter, et al. ('110 patent); U.S. Pat. No. 6,052,122 to Sutcliffe et al. ('122 patent); and U.S. Pat. No. 5,676,551 to Knight et al. ('551 patent); all three of which are incorporated herein by reference.

The '110 patent describes a system and method for analyzing customer behavior based on the time when those behaviors occur. This invention captures information about customer transactions and interactions over time, classifies customers into one or more clusters based on their time-based interactions and transactions, or both, and uses this classification to perform selected target marketing and cross-selling. This is performed by temporally tagging customer transactions and interactions, analyzing the tagged information to create temporal profiles, creating advertising campaigns aimed at the temporal profiles, triggering an advertising campaign, and analyzing the effectiveness of the advertising campaign.

The '122 patent describes a system of matching a first user with at least one other user of the system by comparing criteria data of the first user with characteristic data of the at least one other user and criteria data of the at least one other user with characteristic data of the first user. The characteristic and criteria data can be obtained via the Internet, and more specifically through a series of web site screens that prompt the user for characteristic and preference data. The system performs the comparison of the respective characteristic and criteria data to provide a list of matches to the first user. The first user is furnished with information that allows the first user to contact the other users for which a match has been found.

The '551 patent describes an interactive presentation and/or entertainment system, such as interactive personal computer software and/or interactive television, which allows a participant to modulate the emotions of a character or personality, thereby influencing the branches to an interpersonal relationship over time. As a result, a broad range of computerized dramatic situations or stories are presented that closely resemble human interpersonal relationships. Source image/sound data may include prerecorded video, prerecorded audio, computer-based audio, computer-based imagery, computer-generated dialogue, and/or computer-generated characters. The range of emotional choices made by a participant may include all emotions that human beings can experience and in turn, represent by thought, word, or action.

The above inventions do not describe a method and system of identifying Character Portraits which define inherent, natural, multidimensional, and primarily fixed character traits while using an interactive terminal for entertainment, revenue and market segmentation purposes. Character Portrait revenue is typically generated by the user paying for the Character Portraits rather than a system which captures user information without the user paying and generates revenue some other way. Character Portrait users do not participate in modulating or adjusting the “emotions” of a computerized character or personality, and do not participate in a computerized situation or story. Character Portraits are not determined by customer behavior, nor are they determined by purchasing behavior or purchasing transaction patterns, nor are they based on short-term time intervals.

Consequently, there is a need for system and method for using an interactive terminal to determine a person's Character Portrait for entertainment purposes.

There is a further need in the art for a system and method for using an interactive terminal to determine a person's Character Portrait for increasing the revenue of airline, cruise line and hotel operators.

There is a further need in the art for a system and method for using an interactive terminal to determine a person's Character Portrait for market segmentation purposes.

### SUMMARY OF THE INVENTION

Generally described, the present invention provides a method and system of identifying Character Portraits for entertainment, revenue generation and market segmentation purposes.

In a preferred embodiment of the invention, what is provided is a method for market segmentation, comprising selecting market criteria data for segmenting a market; selecting characteristic data of the market; combining the market criteria data and the characteristic data to create a selected market; segmenting the selected market by using a character portrait system, thereby producing Character Portrait data of the market; and using the character portrait data for making decisions regarding members of the selected market.

In an alternate embodiment, the invention provided is a method for market segmentation using a character portrait system, comprising selecting market criteria data for segmenting a market; selecting characteristic data of the market; combining the market criteria data and the characteristic data to create a selected market; segmenting the selected market by using a character portrait system, thereby producing Character Portrait data of the market; and using the character portrait data for making decisions regarding members of the selected market.

In another alternate embodiment, the invention provided is a system for providing entertainment while enabling the system provider to gather useful data, comprising an interactive terminal, whereby the interactive terminal presents character portrait identification codes used for determining a user's character portrait; an input device, whereby the user uses the input device for responding to Character Portrait Identification Codes; a character portrait dynamic identification processing system, whereby the character portrait dynamic identification processing system determines a user's character portrait; an interactive terminal interface and management system, whereby the interactive terminal interface and management system presents the Character Portrait Identification Codes on the interactive terminal and processes the user input for billing and to initiate operation of the character portrait dynamic identification processing system; and, a character portrait output management system, wherein the character portrait output management system transmits the Character Portrait for delivery to the user.

In another alternate embodiment, the invention provided is a method for providing entertainment while enabling the system provider to gather useful data, comprising presenting Character Portrait Identification Codes to a system user through an interactive terminal; taking user responses through an input device; determining a user's character portrait by a character portrait dynamic identification processing system; processing the user input for billing and for initiating operation of the character portrait dynamic identification processing system using an interactive terminal interface and management system; and, transmitting the Character Portrait for delivery to the user using a character portrait output management system.

In another alternate embodiment, the invention provided is a system for providing entertainment and revenue generation, comprising an interactive terminal, whereby the interactive terminal presents character portrait identification codes used for determining a user's character portrait; an input device, whereby the user uses the input device for responding to Character Portrait Identification Codes; a character portrait dynamic identification processing system, whereby the character portrait dynamic identification processing system determines a user's character portrait; an interactive terminal interface and management system, whereby the interactive terminal interface and management system presents the Character Portrait Identification Codes on the interactive terminal and processes the user input for billing and to initiate operation of the character portrait dynamic identification processing system; and, a character portrait output management system, wherein the character portrait output management system transmits the Character Portrait for delivery to the user.

In another alternate embodiment, the invention provided is a method for providing entertainment and revenue generation, comprising presenting Character Portrait Identification Codes to a system user through an interactive terminal; taking user responses through an input device; determining a user's character portrait by a character portrait dynamic identification processing system; processing the user input for billing and for initiating operation of the character portrait dynamic identification processing system using an interactive terminal interface and management system; and, transmitting the Character Portrait for delivery to the user using a character portrait output management system.

Accordingly, it is an object of the present invention to provide a system and method for using an interactive terminal to determine a person's Character Portrait for entertainment purposes.

It is an additional object of the present invention to provide a method system and method for using an interactive terminal to determine a person's Character Portrait for increasing the revenue of airline, cruise line and hotel operators.

It is an additional object of the present invention to provide system and method for using an interactive terminal to determine a person's Character Portrait for market segmentation purposes.

These and other objects, features, and advantages of the present invention will become apparent upon reading the following specification when taken in conjunction with the accompanying drawings.

### BRIEF DESCRIPTION OF THE DRAWINGS

FIG. 1 is a view of a preferred embodiment of the Character Portrait system used for providing entertainment, revenue and marketing information.

FIG. 2 is an illustration of a screen viewable by the user on an interactive terminal.

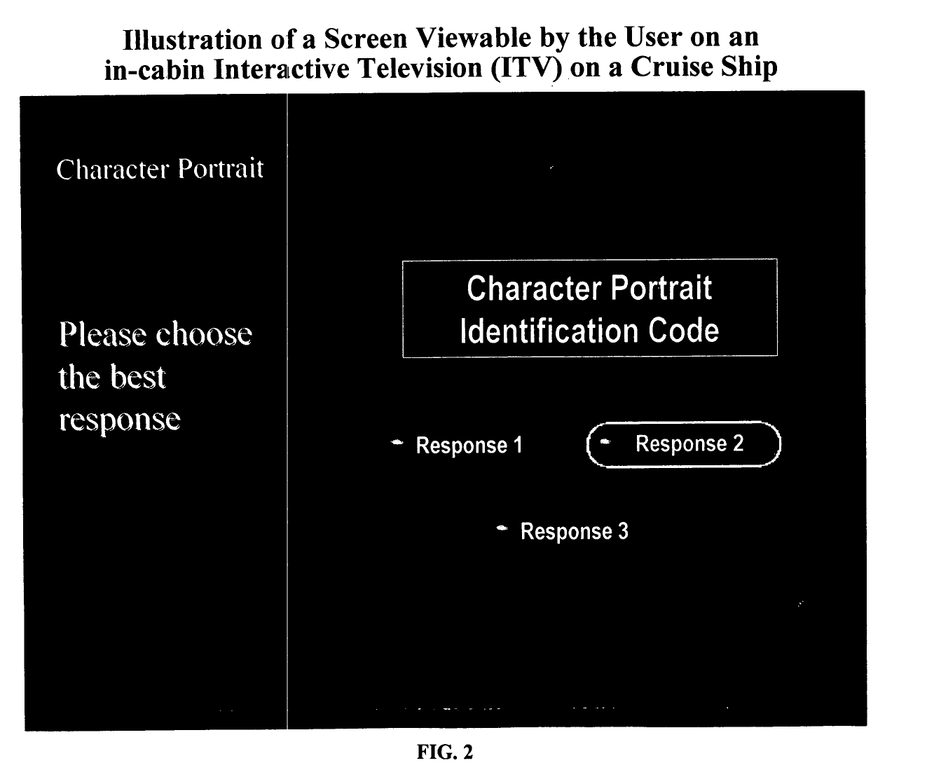

FIG. 3 is a view of a preferred embodiment of the market segmentation method according to the invention.

### DETAILED DESCRIPTION OF THE PREFERRED EMBODIMENT

A Character Portrait System identifies inherent, natural, multidimensional, and primarily fixed character traits and may also incorporate adapted, adopted and/or comparative traits. A Character Portrait as per this definition is independent of gender, age, ethnicity, income, net worth, or current material possessions. Character Portraits are purchased by the user and may be considered to be educational for the user. Character Portraits are not determined by customer behavior, purchasing behavior or purchasing transaction patterns. Further, a person's Character Portrait is not based on short-term time intervals and doesn't vary over short time intervals.

The Character Portrait System is a method designed to draw a person's Character Portrait using a variety of techniques, called Character Portrait Identification Codes, which may include but are not limited to pictures, multiple choice questions, games, narratives, statements, true-false questions, drawings, short answer questions, illustrations, adjectives, essay questions, forced choice questions, descriptors, images, surveys, interviews, stories, observations, Enneagram tests, Print tests, Print test with or without a tie-breaker heuristic, Major and Minor Print, Major Print only, paper tests, online tests, computer-based tests, etc. Character Portrait Identification Codes are part of the Character Portrait Dynamic Identification Processing System.

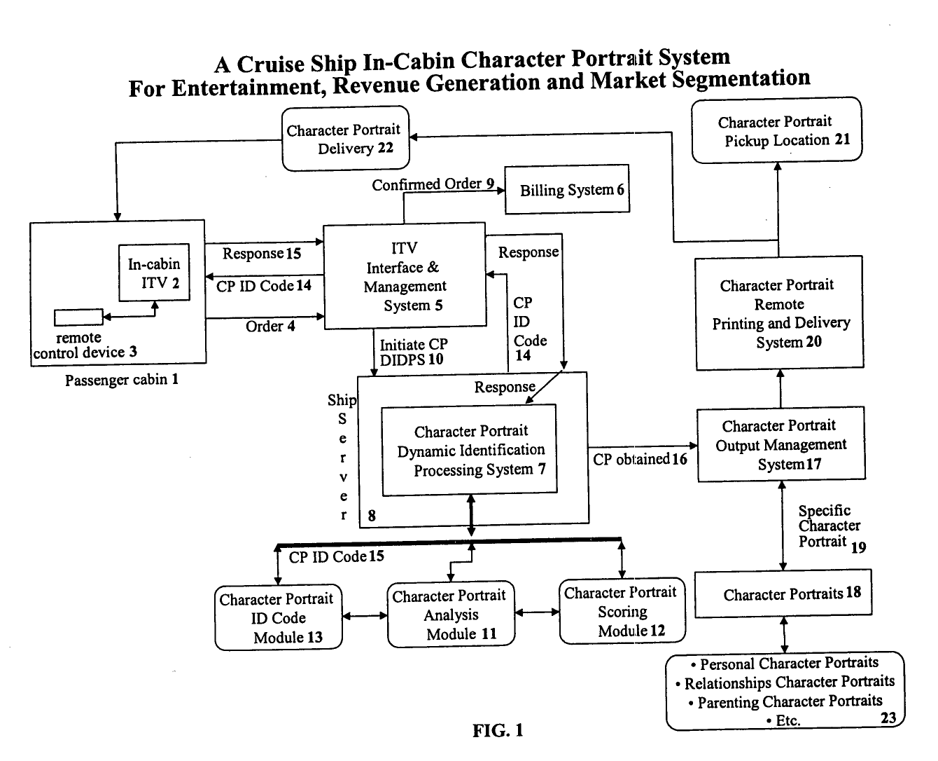

Referring initially to FIG. 1 of the drawings, in which like numerals indicate like elements throughout the several views, in a preferred embodiment the entertainment system is comprised of an interactive television (“ITV”) 2 with a Character Portrait introduction, general description and ordering information in the passenger cabin 1. The passenger has a remote entry device such as a remote control 3 which is used to get the information, and order the Character Portrait.

The order 4 is registered to the ITV Interface & Management System (“ITVI&M System”) 5 which manages the in-cabin ITV and is the interface between 1) ITV order entries and the Ship's Billing System 6, and 2) the ITV responses and the Character Portrait Dynamic Identification Processing System (“CPDIDP System”) 7 which resides on one of the ship's servers 8. The ITVI&M System and the CPDIDP System could reside on the same server or different servers or have some other configuration.

The ITVI&M System sends the order information back to the ITV for passenger confirmation and once that is received, the confirmed order 9 is then sent by the ITVI&M System to the ship's Billing System. The Billing System bills the passenger account. Once the Billing System completes adding the charges to the passenger account, the ITVI&M System initiates 10 the CPDIDP System.

The CPDIDP System consists of three modules—1) the Character Portrait Analysis Module 11, 2) the Character Portrait Scoring Module 12, and 3) the Character Portrait Identification Code Module 13. The Character Portrait Analysis Module 11 is where the user responses to the Character Portrait Identification Codes are analyzed and converted into appropriate scores. The Character Portrait Scoring Module 12 contains the scoring algorithms and rules, where it is a) determined whether or not additional Character Portrait Identification Codes are required and b) if so, which Identification Codes to send to the user, and c) if no further Identification Codes are required, determines the final Character Portrait. The Character Portrait Identification Code Module 13 contains the specific items which draw the Character Portrait. Identification Codes may include but are not limited to pictures, multiple choice questions, games, narratives, statements, true-false questions, drawings, short answer questions, illustrations, adjectives, essay questions, forced choice questions, descriptors, images, surveys, interviews, stories, observations, Enneagram tests, Print tests, Print test with or without a tie-breaker heuristic, Major and Minor Print, Major Print only, paper tests, online tests, computer-based tests, etc. It may be that these three modules are combined and the analysis, scoring and identification codes are in one or two modules rather than separated into three modules. Or all three modules can be part of the CPDIDP System rather than separate modules.

The CPDIDP System polls the Character Portrait Analysis Module 11 which in turn accesses the Character Portrait Scoring Module 12, and the Character Portrait Identification Code Module 13. Based on this information, the CPDIDP System sends the next Character Portrait Identification Code 14 to put in front of the passenger. The selected Character Portrait Identification Code goes through the CPDIDP System to the ITVI&M System to the ITV. The passenger provides a response 15 using the remote control device and the response is carried back through the ITV to the ITVI&M System to the CPDIDP System where the CPDIDP System accesses the modules to analyze, score and decide if another Character Portrait Identification Code is necessary, and if so, the next Character Portrait Identification Code to put in front of the passenger.

This process is repeated in a loop until the CPDIDP System determines that a Character Portrait has been obtained 16 and therefore no more Character Portrait Identification Codes need to be put in front of the passenger. This signal that a Character Portrait is obtained is sent to the Character Portrait Output Management System 17 which accesses the Character Portraits 18 and flags the correct Character Portrait.

This specific Character Portrait 19 is sent by the Character Portrait Output Management System to the Character Portrait Remote Printing and Delivery System 20. The “printing” of the Character Portrait could be a printer at a remote site, a printer in the passenger cabin, printed at the purser's desk, printed on the in-cabin ITV screen or some other configuration. The Character Portrait can be picked up at a particular location on the ship 21, the purser's desk for example, and/or delivered to the passengers cabin 22, for example by a stateroom steward or by room service personnel.

Different Character Portraits could be used in the system described above. All of these different Character Portraits are based on the above definition of a Character Portrait—that is, a Character Portrait defines inherent, natural, multidimensional, and primarily fixed character traits. These different Character Portraits could include: 1) a Personal Character Portrait which is a Character Portrait of an individual user and which may contain elements as described above, 2) a Relationship Character Portrait which is a Character Portrait of the relationship between two individuals and which may contain elements such as areas of compatibility, potential areas of conflict, and ways each person can improve communication, get along better with the other person, not “trigger” the other person and improve the relationship, 3) a Parenting Character Portrait which is a Character Portrait of an individual and which may contain elements such as areas of parenting strength, potential areas of parenting challenges or weaknesses, and ways the person can improve parenting skills, 4) a Career Character Portrait which is a Character Portrait of an individual and which may contain elements such as areas of career characteristics that are a natural fit for the person, career characteristics that are out the person's natural “comfort zone”, organizational environments that are more naturally suited for that person, and organizational environments that are less naturally suited for that person, 5) a Leadership Character Portrait which is a Character Portrait of an individual and which may contain elements such as areas of leadership strength, potential areas of leadership challenges or weaknesses, and ways the person can improve leadership skills, 6) a Productivity Character Portrait which is a Character Portrait of an individual and which may contain elements such as areas of productivity strength, potential areas of productivity challenges or weaknesses, and ways the person can improve productivity, 7) a Team Character Portrait which is a Character Portrait of team and which may contain elements such as areas of team compatibility, potential areas of team conflict, and ways team members can improve communication, get along better with other team members, not “trigger” the other team members and improve the performance and effectiveness, and so on 23. These are some of the possible Character Portraits, there are others, and different Character Portraits or elements of Character Portraits may be combined. For example, a Leadership Character Portrait, or parts of that Portrait, may be combined with a Productivity Character Portrait, or parts of that Portrait, into one Portrait.

In addition to being used for entertainment and/or educational purposes for the vacationer and revenue purposes for the airline, cruise line or hotel operator, Character Portraits can be used for market segmentation. The market segmentation system of the present invention utilizes two basic inputs to determine the selected market 30. The first input, characteristic data of the market 32, defines the targeted market. The second input is the market criteria data 34 of the company operating the system. These criteria 34 define the market on which the company is seeking to concentrate. The two inputs, 32 and 34, overlay to define the selected market 30. A market can loosely be defined as a collection of people who are segmented or grouped according to a particular purpose or characteristic(s) which could include anything from people who like to go on excursions, people attending a seminar, passengers on a cruise, political affiliations, guests in a hotel, people on an airline flight, people who volunteer for charities, people looking for a job, etc. The market segmentation system is used to understand and make decisions about the market.

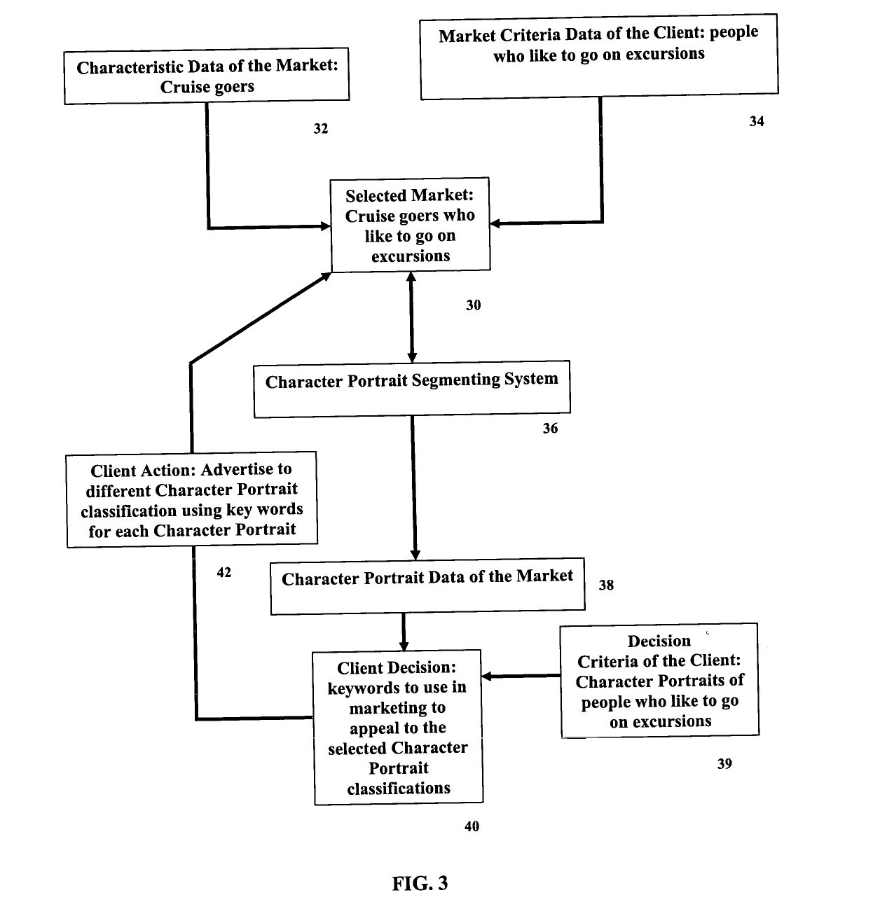

FIG. 3 illustrates how the present system, can be used for marketing. In this scenario, the characteristic data of the market 32, could be those people who patronize cruise ships. The market criteria data 34 could specify that the client is only interested in the people who prefer to go on excursions. The selected market 30 is therefore those people who go on cruises and prefer to go on excursions over other forms of entertainment. The market segmentation means 36 is then used to determine Character Portraits of those people, the goal being to identify which Character Portraits go on excursions the most frequently, or even more specifically which Character Portraits go on which excursions. The Character Portrait data 38 produced is used by the company to make marketing decisions by coupling the Character Portrait data 38 with the decision criteria 39. In this case, the decision criteria 39 are pre-defined words, images or scenarios to which certain Character Portraits are attracted. For example, the data 38 could show that Character Portrait classifications α and δ are excursion lovers, and that those Character Portraits are attracted to words such as “fast” and “powerful”, and images or scenarios that illustrate people doing things quickly and people being in control and making their own decisions. Therefore, “fast” and “powerful” are in the data set that defines the decision criteria 39. Once the decision 40 is made, the company effectuates 42 its plan based upon the Character Portrait data (a and 6 key words, images or scenarios) 38 of the market.

A useful enhancement to the system would be in generating a database of the likes and dislikes of the different Character Portraits. For example, the cars each Character Portrait drives, the movies they watch, the food they eat, the magazines they read, the television shows they watch, the music they listen to, etc., including, but not limited to, anyone that you'd want to contact or reach with targeted Character Portrait-specific information.

Accordingly, it will be understood that the preferred embodiment of the present invention has been disclosed by way of example and that other modifications and alterations may occur to those skilled in the art without departing from the scope and spirit of the appended claims.

The invention claimed is:

1. A method for market segmentation, comprising:
selecting market criteria data for segmenting a market;
selecting characteristic data of said market;
combining said market criteria data and said characteristic data to create a selected market;
segmenting said selected market by using a character portrait system, thereby producing Character Portrait data of the market; and,
using said character portrait data for making decisions regarding members of said selected market.

2. The method of claim 1, whereby market sub-segments may further be produced by said segmenting.

3. The method of claim 1, whereby market segmentation is applied to the cruise ship industry.

4. The method of claim 1, whereby market segmentation is applied to the hotel industry.

5. The method of claim 1, whereby market segmentation is applied to the airline industry.

6. A method for market segmentation using a character portrait system, comprising:
selecting market criteria data for segmenting a market;
selecting characteristic data of said market;
combining said market criteria data and said characteristic data to create a selected market;
segmenting said selected market by using a character portrait system, thereby producing Character Portrait data of the market; and,
using said character portrait data for making decisions regarding members of said selected market.

7. A method as in claim 6, whereby market sub-segments may also be produced by said segmenting.

8. The method of claim 6, whereby market segmentation is applied to the cruise ship industry.

9. The method of claim 6, whereby market segmentation is applied to the hotel industry.

10. The method of claim 6, whereby market segmentation is applied to the airline industry.

11. A system for providing entertainment while enabling the system provider to gather useful data, comprising:
an interactive terminal, whereby said interactive terminal presents character portrait identification codes used for determining a user's character portrait;
an input device, whereby said user uses said input device for responding to said character portrait identification codes;
a character portrait dynamic identification processing system, whereby said character portrait dynamic identification processing system determines a user's character portrait;
an interactive terminal interface and management system, whereby said interactive terminal interface and management system presents said character portrait identification codes on said interactive terminal and processes said user input for billing and to initiate operation of said character portrait dynamic identification processing system; and,
a character portrait output management system, wherein said character portrait output management system transmits said character portrait for delivery to said user.

12. The system of claim 11, wherein said interactive terminal is a television, a computer, a personal data assistant (PDA), or a telephone with a video screen.

13. The system of claim 11, wherein said input device is a wireless remote control, a keyboard, a game pad, or a joystick.

14. The system of claim 11, wherein said character portrait dynamic identification processing system determines additional information to be presented on said interactive terminal by analyzing successive character portrait identification codes.

15. The system of claim 14, wherein said identification codes are determined by accessing scoring, analysis, identification and portrait models software modules.

16. The system of claim 11, wherein said character portrait could be a personal character portrait, a relationship character portrait, a parenting character portrait, a career character portrait, a leadership character portrait, a productivity character portrait, or a team character portrait.

17. The system of claim 11, whereby said system is used in the cruise ship industry.

18. The system of claim 11, whereby said system is used in the hotel industry.

19. The system of claim 11, said system is used in the airline industry

20. The system of claim 11, wherein said system utilizes user input information and said character portrait results for decision making and/or market segmentation purposes.

21. A method for providing entertainment while enabling the system provider to gather useful data, comprising:
presenting character portrait identification codes to a system user through an interactive terminal;
taking user responses through an input device;
determining a user's character portrait by a character portrait dynamic identification processing system;
processing said user input for billing and for initiating operation of said character portrait dynamic identification processing system using an interactive terminal interface and management system; and,
transmitting the character portrait for delivery to said user using a character portrait output management system.

22. The method of claim 21, wherein said interactive terminal is a television, a computer, a personal data assistant (PDA), or a telephone with a video screen.

23. The method of claim 21, wherein said input device is a wireless remote control, a keyboard, a game pad, or a joystick.

24. The method of claim 21, wherein said character portrait dynamic identification processing system determines additional information to be presented on said interactive terminal by analyzing successive character portrait identification codes.

25. The method of claim 24, wherein said identification code is determined by accessing scoring, analysis, identification and portrait models software modules.

26. The method of claim 21, wherein said character portrait could be a personal character portrait, a relationship character portrait, a parenting character portrait, a career character portrait, a leadership character portrait, a productivity character portrait, or a team character portrait.

27. The method of claim 21, whereby said method is applied to the cruise ship industry.

28. The method of claim 21, whereby said method is applied to the hotel industry.

29. The method of claim 21, whereby said method is applied to the airline industry.

30. The method of claim 21, wherein said system utilizes user input information and said character portrait results for decision making and/or market segmentation purposes.

31. A system for providing entertainment and revenue generation, comprising:
an interactive terminal, whereby said interactive terminal presents character portrait identification codes used for determining a user's character portrait;
an input device, whereby said user uses said input device for responding to said character portrait identification codes;
a character portrait dynamic identification processing system, whereby said character portrait dynamic identification processing system determines a user's character portrait;
an interactive terminal interface and management system, whereby said interactive terminal interface and management system presents said character portrait identification codes on said interactive terminal and processes said user input for billing and to initiate operation of said character portrait dynamic identification processing system; and,
a character portrait output management system, wherein said character portrait output management system transmits said character portrait for delivery to said user.

32. The system of claim 31, wherein said interactive terminal is a television, a computer, a personal data assistant (PDA), or a telephone with a video screen.

33. The system of claim 31, wherein said input device is a wireless remote control, a keyboard, a game pad, or a joystick.

34. The system of claim 31, wherein said character portrait dynamic identification processing system determines additional information to be presented on said interactive terminal by analyzing successive character portrait identification codes.

35. The system of claim 34, wherein said identification codes are determined by accessing scoring, analysis, identification and portrait models software modules.

36. The system of claim 31, wherein said character portrait could be a personal character portrait, a relationship character portrait, a parenting character portrait, a career character portrait, a leadership character portrait, a productivity character portrait, or a team character portrait.

37. The system of claim 31, whereby said system is used in the cruise ship industry.

38. The system of claim 31, whereby said system is used in the hotel industry.

39. The system of claim 31, said system is used in the airline industry.

40. The method of claim 31, wherein said system utilizes user input information and said character portrait results for decision making and/or market segmentation purposes.

41. A method for providing entertainment and revenue generation, comprising:
presenting character portrait identification codes to a system user through an interactive terminal;
taking user responses through an input device;
determining a user's character portrait by a character portrait dynamic identification processing system;
processing said user input for billing and for initiating operation of said character portrait dynamic identification processing system using an interactive terminal interface and management system; and,
transmitting the character portrait for delivery to said user using a character portrait output management system.

42. The method of claim 41, wherein said interactive terminal is a television, a computer, a personal data assistant (PDA), or a telephone with a video screen.

43. The method of claim 41, wherein said input device is a wireless remote control, a keyboard, a game pad, or a joystick.

44. The method of claim 41, wherein said character portrait dynamic identification processing system determines additional information to be presented on said interactive terminal by analyzing successive character portrait identification codes.

45. The method of claim 44, wherein said identification code is determined by accessing scoring, analysis, identification and portrait models software modules.

46. The method of claim 41, wherein said character portrait could be a personal character portrait, a relationship character portrait, a parenting character portrait, a career character portrait, a leadership character portrait, a productivity character portrait, or a team character portrait.

47. The method of claim 41, whereby said method is applied to the cruise ship industry.

48. The method of claim 41, whereby said method is applied to the hotel industry.

49. The method of claim 41, whereby said method is applied to the airline industry.

50. The method of claim 41, wherein said system utilizes user input information and said character portrait results for decision making and/or market segmentation purposes.
